(19) United States
(12) Patent Application Publication
(10) Pub. No.: US 2008/0135652 A1
(43) Pub. Date: Jun. 12, 2008

(54) Safety device that can close paper passage of shredder

(75) Inventor: Simon Huang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/797,396

(22) Filed: May 3, 2007

(30) Foreign Application Priority Data
Dec. 12, 2006 (TW) 095221845

(51) Int. Cl. B02C 4/32

(52) U.S. Cl. 241/37

(57) ABSTRACT

A safety device that can close the paper passage of a shredder has a touch board pivoted in the vicinity of the shredder opening. When the board is under a pressure produced by fingers touching the opening, it is rotated about its pivotal axis. Its rotation drives a transmission mechanism and a closing element to close the opening. Therefore, the fingers cannot go into the opening and get hurt. Once the pressure on the touch board disappears, a restoring element pushes the touch board back to its normal position and brings the closing element away from the closing position. The opening is thus open again.

### BACKGROUND OF THE INVENTION

1. Field of Invention

The invention relates to a shredder and, in particular, to a safety device for the shredder that closes the lower opening of paper entry when fingers enter the opening for protecting the user.

2. Related Art

To prevent such documents as legal files, receipts, invoices, credit card numbers, research reports, or personal financial information (e.g., credit card and phone bills) from being released, it is common to destroy them using a shredder. Therefore, the shredder has become an indispensable device for both business and home applications.

The US Consumer Product Safety Commission (CPSC) issued document No. 5127 in response to paper shredder safety alert. The document reminded families with shredders to be cautious about the safety in operating the shredders. It pointed out that 31 cases of finger injuries from operating shredders have been the received reports between January 2000 and December 2003, and most of the people who got hurt were children aged from 14 months to 2 years, particularly the toddlers. This is because children at these ages like to mimic adults and play shredder without the adult's supervision. It is not guaranteed that no accident will happen even under the adult's supervision. This is because the pulling force exert by the shredder on the paper is very large. If the fingers holding the paper do not let go, the pulling force may also pull the fingers into the shredder opening and cause injuries.

Therefore, the CPSC cautioned consumers about the following things:
1. Do not let children to operate shredders by themselves. Even under supervision, the adult should know that there is a risk that the pulling force of the shredder may be strong enough to pull children's fingers into the shredder opening.
2. Keep shredders away from children.
3. Unplug the shredder when not in use.
4. Do not put hands or fingers on the shredder.
5. Do not operate shredders when wearing clothes with loose ends or strips to avoid being pulled into the shredder opening.
6. Keep an appropriate distance between the tie or zipper and the shredder opening.

The opening width of an ordinary shredder may be wide enough for a child to stick in fingers and get hurt by the blades. Therefore, it is imperative to provide a safety protection device at the opening to prevent injuries.

### SUMMARY OF THE INVENTION

In view of the foregoing, an objective of the invention is to provide a safety device that can close the paper passage of a shredder when a finger is inserted for preventing any injury.

To achieve the above objective, the disclosed safety device that can close the paper passage of a shredder has a touch board pivoted in the vicinity of the shredder opening. When the board is under a pressure produced by fingers touching the opening, it is rotated about its pivotal axis. Its rotation drives a transmission mechanism and a closing element to close the opening. Therefore, the fingers cannot go into the opening and get hurt. Once the pressure on the touch board disappears, a restoring element pushes the touch board back to its normal position and brings the closing element away from the closing position. The opening is thus open again.

### BRIEF DESCRIPTION OF THE DRAWINGS

The invention will become more fully understood from the detailed description given herein below illustration only, and thus is not limitative of the present invention, and wherein:

FIG. 1 is a planar view showing the structure of the invention in its normal state; and

FIG. 2 is a planar view showing the structure of the invention when the touch board is under a pressure.

### DETAILED DESCRIPTION OF THE INVENTION

The present invention will be apparent from the following detailed description, which proceeds with reference to the accompanying drawings, wherein the same references relate to the same elements.

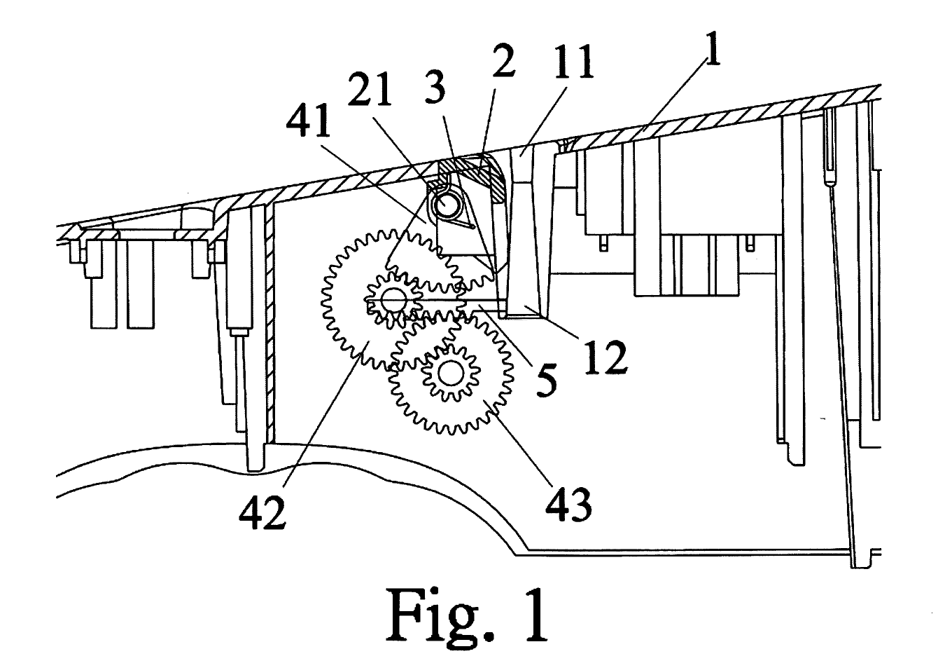

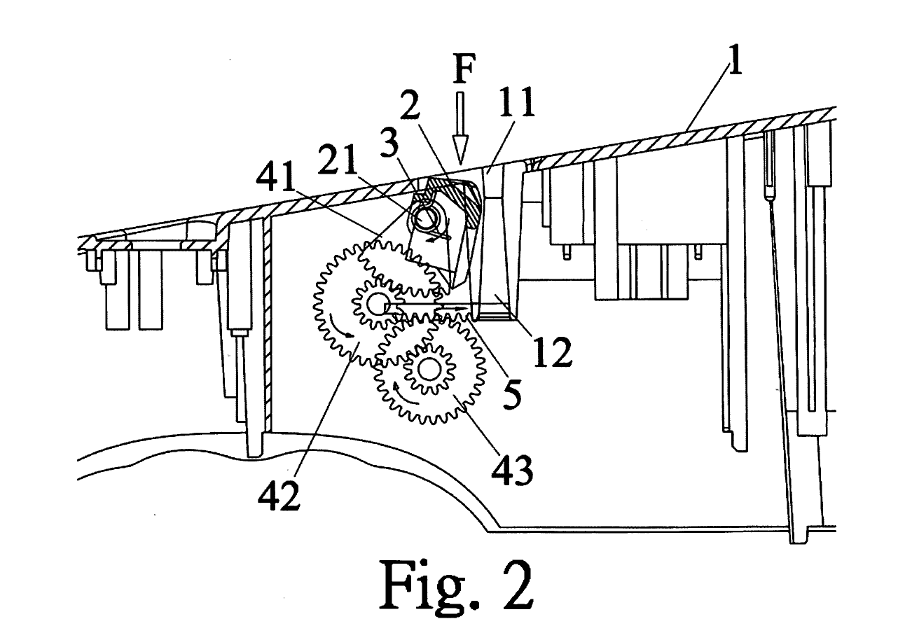

FIG. 1 is a planar view showing the structure of the invention in its normal state. FIG. 2 is a planar view showing the structure of the invention when the touch board is under a pressure.

As shown in FIG. 1, the upper opening 11 of the paper passage of the shredder case 1 is pivotally installed with a touch board 2. The pivotal position 21 of the touch board 2 is disposed with a restoring element 3, which in this embodiment is a torque spring. One end of the torque spring touches against the inner rim of the touch board. The other end is fixed on a wedge active gear 41 of a transmission mechanism. The wedge active gear 41 is fixed at the pivotal position 21 of the touch board 2 and engaged with a first passive gear 42. The first passive gear 42 is further engaged with a second passive gear 43. The second passive gear 43 is then engaged with a tooth bar 5.

As shown in FIG. 2, when the touch board 2 is under the pressure produced by an inserted finger (as indicated by the arrow F), the touch board 2 rotates clockwise with respect to the pivotal position 21 of the shredder case 1. Such a rotation drives the wedge active gear 41 in the transmission mechanism, the first passive gear 42, and the second passive gear 43 to rotate in the directions indicated by the arrows. The tooth bar 5 engaged with the second passive gear 43 moves toward the lower opening 12 of the paper passage and closes it. As the touch board 2 is under pressure to rotate clockwise, the torque spring 3 is twisted to store its restoration energy.

When the pressure F of the finger on the touch board 2 disappears as the finger is removed, the torque spring 3 releases its stored energy so that the touch board 2 rotates in the counterclockwise direction back to its normal position. At the same time, the wedge active gear 41 in the transmission mechanism, the first passive gear 42, and the second passive gear 43 are driven to rotate in the reverse directions. The tooth bar 5 engaged with the second passive gear 43 is then pulled away from the lower opening 12 of the paper passage, thereby opening the opening.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A safety device that closes the paper passage of a shredder, comprising:
a shredder case, which has an opening;
a touch board, which is pivoted in the vicinity of the opening of the shredder case and rotates with respect to the pivotal position; and
a closing element, which is driven by the touch board and moves between an opening position and a closing position of the paper passage.

2. A safety device that closes the paper passage of a shredder according to claim 1, wherein the touch board drives the closing element via a transmission mechanism.

3. A safety device that closes the paper passage of a shredder according to claim 2, wherein the transmission mechanism includes an active gear fixed at the pivotal position of the touch board and engaged with a first passive gear, the first passive gear is further engaged with a second passive gear, and the second passive gear displaces the closing element.

4. A safety device that closes the paper passage of a shredder according to claim 3, wherein the closing element is a tooth bar engaged with the second passive gear.

5. A safety device that closes the paper passage of a shredder according to claim 3, wherein the pivotal position of the touch board is disposed with a restoring element whose one end touches against the touch board and whose other end is fixed at the transmission mechanism.

6. A safety device that closes the paper passage of a shredder according to claim 5, wherein the restoring element is a torque spring.
